(19) United States
(12) Patent Application Publication
(10) Pub. No.: US 2006/0179107 A1
(43) Pub. Date: Aug. 10, 2006

(54) Network recording system, recording server, and terminal device

(76) Inventors: Yoshiaki Iwata, Moriguchi-shi (JP); Keiji Icho, Matsubara-shi (JP); Kentaro Tanikawa, Kadoma-shi (JP)

Correspondence Address: WENDEROTH, LIND & PONACK L.L.P., 2033 K. STREET, NW, SUITE 800, WASHINGTON, DC, 20006, US

(21) Appl. No.: 10/560,809

(22) PCT Filed: Jun. 7, 2004
(86) PCT No.: PCT/JP04/08252

§ 371 Date: Dec. 15, 2005

(30) Foreign Application Priority Data
Jun. 18, 2003 (JP) 2003-172877

(51) Int. Cl. G06F 15/16

(52) U.S. Cl. 709/203

(57) ABSTRACT

A network recording system includes a recording server and a terminal device. The terminal device includes a receiving unit operable to receive a designation of a program to be recorded, from a user, a selecting unit operable to select a user profile to which the user belongs, out of a plurality of user profiles, and a transmitting unit operable to transmit recording instruction information to the recording server, where the recording instruction information includes a combination of a program ID identifying the program to be recorded and user profile information showing the user profile to which the user belongs. The recording server includes a reception unit operable to receive the recording instruction information from the terminal device, a recording unit operable to record the program identified by the program ID included in the recording instruction information, and a counting unit operable to count, for each of the plurality of user profiles, a number of times each program ID has been received by the reception unit.

### TECHNICAL FIELD

The present invention relates to a network system including terminal devices and a recording server that are connected to a network. The present invention especially relates to a technique to analyze a general tendency relating to recording instructions, based on recording instruction information transmitted from the terminal devices to the recording server.

### BACKGROUND ART

Nowadays, various types of video distribution services using a network such as the Internet and a Local Area Network (LAN) are provided. One of such services is a program recording service.

The following explains the program recording service. A recording center receives, via a network, information relating to an instruction to record a program (hereinafter referred to as “recording instruction information”) from a terminal device (e.g. a mobile telephone) owned by a user of the service. A recording server included in the recording center then records the program in place of the terminal device. The recording server transmits data of the recorded program to the terminal device via the network, upon receiving a request from the terminal device.

Here, a provider of the program recording service may use recording instruction information transmitted from terminal devices, in order to know a general tendency relating to recording instructions or to provide a program recommendation service of recommending programs which match preferences of individual users.

In this case, the provider of the program recording service presents a privacy policy to the users and obtains the users' agreement on the policy, before providing the program recording service. Such a privacy policy shows how information relating to the users' privacy such as recording instruction information is collected, for what purpose the collected information is used, and how the collected information is protected.

However, privacy awareness has been recently increasing. This tends to increase the number of users who do not want the service provider to analyze their preferences on programs.

Therefore, if the service provider analyzes preference about programs of each particular user, i.e. knows that a user A likes animated cartoons, potential users may be discouraged from using the program recording service.

### DISCLOSURE OF THE INVENTION

The present invention was made considering those who have high privacy awareness. It is a first object of the present invention to provide a network recording system in which a service provider makes various analyses on a tendency relating to recording instructions based on recording instruction information without identifying individual users, and various techniques relating to the system.

It is a second object of the present invention to provide a network recording system which recommends programs which match preferences of individual users based on the result of the analyses on the tendency relating to recording instructions, and various techniques relating to the system.

The first object can be achieved by a network recording system including a terminal device and a recording server which are connected to a network. The terminal device comprises a receiving unit operable to receive a designation of a program to be recorded, from a user, a selecting unit operable to select a user profile to which the user belongs, out of a plurality of user profiles, and a transmitting unit operable to transmit recording instruction information to the recording server, where the recording instruction information includes a combination of a program ID identifying the program to be recorded and user profile information showing the user profile to which the user belongs. The recording server comprises a reception unit operable to receive the recording instruction information from the terminal device, a recording unit operable to record the program identified by the program ID included in the recording instruction information, and a counting unit operable to count, for each of the plurality of user profiles, a number of times each program ID has been received by the reception unit.

The first object can be achieved by a recording server comprising a reception unit operable to receive, from an external device, recording instruction information including a combination of a program ID identifying a program and user profile information indicating a user profile to which a user belongs, a recording unit operable to record the program identified by the program ID included in the recording instruction information, and a counting unit operable to count, for each of a plurality of user profiles, a number of times each program ID has been received by the reception unit.

The first object can be achieved by a designated program counting system including a terminal device and a server which are connected to a network. The terminal device comprises a receiving unit operable to receive a designation of a program, from a user, a selecting unit operable to select a user profile to which the user belongs, out of a plurality of user profiles, and a transmitting unit operable to transmit instruction information to the server, where the instruction information includes a combination of a program ID identifying the designated program and user profile information showing the user profile to which the user belongs. The server comprises a reception unit operable to receive the instruction information from the terminal device, and a counting unit operable to count, for each of the plurality of user profiles, a number of times each program ID has been received by the reception unit.

The first object can be achieved by a recording-instructed program counting method comprising steps of receiving recording instruction information including a combination of a program ID and user profile information, recording a program identified by the program ID included in the recording instruction information, and counting a number of times, for each of a plurality of user profiles, each program ID has been received in the receiving step.

The first object can be achieved by a computer-readable program to cause a computer to execute a program counting operation comprising steps of receiving recording instruction information including a combination of a program ID and user profile information, recording a program identified by the program ID included in the recording instruction information, and counting a number of times, for each of a plurality of user profiles, each program ID has been received in the receiving step.

The first object can be achieved by a computer-readable storage medium storing a computer-readable program which causes a computer to execute a program counting operation. The program counting operation comprises steps of receiving recording instruction information including a combination of a program ID and user profile information, recording a program identified by the program ID included in the recording instruction information, and counting a number of times, for each of a plurality of user profiles, each program ID has been received in the receiving step.

The first object can be achieved by an integrated circuit for use in a recording server including a transmission unit operable to transmit, to a terminal device, a rule to select, out of a plurality of user profiles, a user profile to which a user belongs, a reception unit operable to receive recording instruction information including a combination of a program ID identifying a program to be recorded and user profile information indicating the user profile to which the user belongs, and a recording unit operable to record the program indicated by the program ID included in the recording instruction information. The integrated circuit comprises a rule generating unit operable to generate the rule, and a counting unit operable to count, for each of the plurality of user profiles, a number of times each program ID has been received by the reception unit.

Here, a user profile is attribute information indicating a different one of a plurality of groups that belong to a particular category. The user profile does not uniquely identify a user or a terminal device.

According to the above-mentioned construction, a service provider counts, for each user profile, the number of times each program ID has been received by the reception unit. In this way, the service provider can analyze a tendency relating to recording instructions, for each user profile. Thus, the service provider does not know preference of each particular user. As a result, even those who have high privacy awareness are motivated to use the program recording service.

Here, the recording server may further comprises a rule generating unit operable to generate a rule to select the user profile to which the user belongs, and a transmission unit operable to transmit the generated rule to the terminal device. The terminal device may further comprises a rule storing unit operable to receive and store the rule transmitted from the recording server, and the selecting unit may select the user profile to which the user belongs, based on the rule stored in the rule storing unit.

According to this construction, the user profile to which the user belongs is determined based on the rule generated in the recording server. Since the recording server is managed by the service provider, the service provider can make various analyses on a tendency relating to recording instructions for each user profile.

The second object can be achieved in the following manner. The recording server further comprises a selection unit operable to select a plurality of programs in one-to-one correspondence with the plurality of user profiles, based on a result of the counting performed by the counting unit. In addition, the transmission unit generates selected program information and transmits the selected program information to the terminal device, where the selected program information shows a one-to-one correspondence between (i) a plurality of pieces of program information that indicate the plurality of programs selected by the selection unit and (ii) a plurality of pieces of user profile information that represent the plurality of user profiles. In addition, the terminal device further comprises a presenting unit operable to receive the selected program information from the recording server, and present the selected program information to the user.

The second object can be achieved by a terminal device comprising a receiving unit operable to receive a designation of a program to be recorded from a user, a selecting unit operable to select a user profile to which the user belongs, out of a plurality of user profiles, a transmitting unit operable to transmit recording instruction information to an external device, where the recording instruction information includes a program ID identifying the program to be recorded and user profile information indicating the user profile to which the user belongs, a reception unit operable to receive, from the external device, selected program information showing a one-to-one correspondence between (i) a plurality of pieces of program information that respectively indicate programs and (ii) a plurality of pieces of user profile information which respectively represent the plurality of user profiles, and a presenting unit operable to extract a piece of program information corresponding to the user profile to which the user belongs, from the selected program information and present the extracted piece of program information to the user.

The second object can be achieved by an integrated circuit for use in a terminal device including a receiving unit operable to receive, from an external device, a rule to select, out of a plurality of user profiles, a user profile to which a user belongs. The integrated circuit comprises a rule storing unit operable to store the rule received by the receiving unit, and a selecting unit operable to select the user profile to which the user belongs, out of the plurality of user profiles, based on the rule stored in the rule storing unit.

According to these constructions, the user can know a program which matches his preference, based on the selected program information presented on the terminal device.

Here, the presenting unit may extract a piece of program information corresponding to the user profile to which the user belongs, from the selected program information, and present the extracted piece of program information to the user.

According to this construction, the terminal device only presents a program which corresponds to the user profile to which the user of the terminal device belongs. This will spare the user the trouble of searching programs corresponding to the user profile to which the user belongs.

Here, the terminal device may further comprise a program guide information obtaining unit operable to obtain program guide information showing program IDs and corresponding genre IDs that represent program genres of programs identified by the program IDs, and a history storing unit operable to, every time the receiving unit receives a designation of a program to be recorded, determine a genre ID corresponding to a program ID identifying the program to be recorded with reference to the program guide information, and count and record therein a number of times the genre ID is designated by the user. The selecting unit may select the user profile to which the user belongs, based on a result of the counting performed by the history storing unit and the rule stored in the rule storing unit.

According to this construction, a program recording instruction issued by the user automatically determines the user profile to which the user belongs.

Here, the receiving unit may receive an input of personal information from the user, and the selecting unit may select the user profile to which the user belongs, based on the personal information and the rule stored in the rule storing unit.

According to this construction, personal information the user inputs to the terminal device determines the user profile to which the user belongs.

### BRIEF DESCRIPTION OF THE DRAWINGS

FIG. 1 illustrates a construction of a network recording system relating to an embodiment of the present invention.

FIG. 2 is a functional block diagram illustrating a terminal device.

FIG. 3 is a functional block diagram illustrating a recording server.

FIG. 4 illustrates an example of program guide information.

FIG. 5 illustrates an example of a channel table.

FIG. 6 illustrates an example of a GUI screen displayed on a display unit of the terminal device (shown in FIG. 2).

FIG. 7 illustrates an example of a recording instruction history which is stored in the terminal device.

FIG. 8 illustrates a data construction of transmission information transmitted from the terminal device to the recording server.

FIG. 9 illustrates a concrete example of program ID counting information.

FIG. 10 illustrates a concrete example of selected program information.

FIG. 11 is a flow chart to illustrate an operation of the terminal device.

FIG. 12 is a flow chart to illustrate an operation of the terminal device.

FIG. 13 is a flow chart to illustrate an operation of the terminal device.

FIG. 14 illustrates constructions of a recording management server and a recording device included in a network recording system relating to a modification example of the present invention.

### BEST MODE FOR CARRYING OUT THE INVENTION

The following describes a network recording system which is an embodiment of the present invention, with reference to the attached figures.

(1. Construction of the Network Recording System 1)

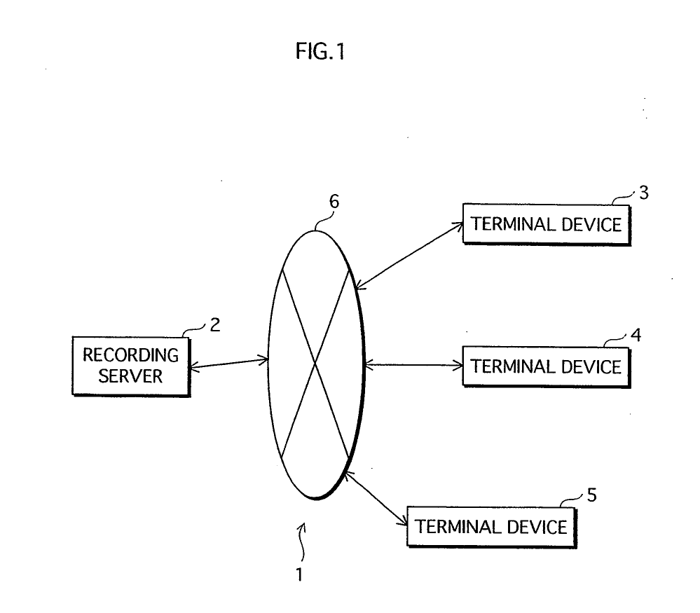

FIG. 1 illustrates a construction of a network recording system 1.

The network recording system 1 includes a recording server 2, terminal devices 3, 4 and 5, a network 6. The number of terminal devices in the network recording system 1 is not limited to three, and can be several thousand to several ten thousand. Likewise, the number of recording servers is not limited to one, and can be several thousand to several ten thousand.

The network 6 is a LAN or the Internet.

Each of the recording server 2, and the terminal devices 3, 4 and 5 is a computer constituted by hardware such as a CPU, an input/output device (e.g. a reception tuner, a communication modem, a User Interface (UI) circuit), a memory and a hard disk.

(1.1. Construction of the Terminal Device 4)

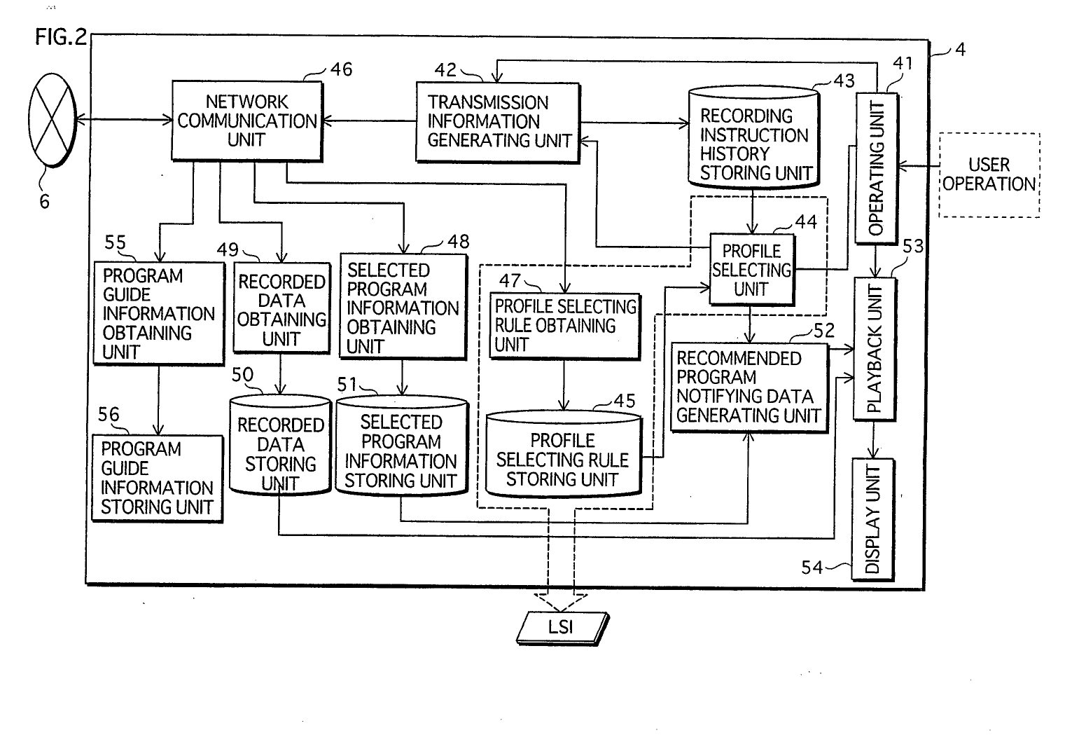

The following part describes functional units of each of the terminal devices 3, 4 and 5. FIG. 2 is a functional block diagram illustrating the terminal device 4.

The terminal device 4 includes an operating unit 41, a transmission information generating unit 42, a recording instruction history storing unit 43, a profile selecting unit 44, a profile selecting rule storing unit 45, a network communication unit 46, a profile selecting rule obtaining unit 47, a selected program information obtaining unit 48, a recorded data obtaining unit 49, a recorded data storing unit 50, a selected program information storing unit 51, a recommended program notifying data generating unit 52, a playback unit 53, a display unit 54, a program guide information obtaining unit 55, and a program guide information storing unit 56.

The terminal devices 3 and 5 have the same functional units as the terminal device 4, and therefore are not explained here.

The functional units of the terminal device 4 are realized in such a manner that a CPU executes a terminal device control program stored in a memory or a hard disk.

As shown in FIG. 2, the profile selecting unit 44, the profile selecting rule storing unit 45, and the profile selecting rule obtaining unit 47 are formed as an integrated circuit.

The network communication unit 46 has a function of communicating with other devices connected to the network 6. The network communication unit 46 is realized by hardware, such as a LAN card or a modem.

The program guide information obtaining unit 55 has a function of obtaining program guide information via the network 6 from the recording server 2. The program guide information storing unit 55 is a memory area for storing the obtained program guide information. The program guide information is described in detail later.

The operating unit 41 has a function of receiving various kinds of user instructions through the user's button operations or the like. For example, the terminal device 4 displays a recording program selection screen of a Graphical User Interface (GUI) on the display unit 54, so as to receive a recording instruction through the user's operations of a pointing device.

A GUI is realized by arranging, for example, icons and buttons on a display screen. The icons and buttons are displayed, for example, as a letter or a picture and each have a specific property. Personal computers and various kinds of audio-video devices, for example, receive operations from users and present information to users, through GUIs.

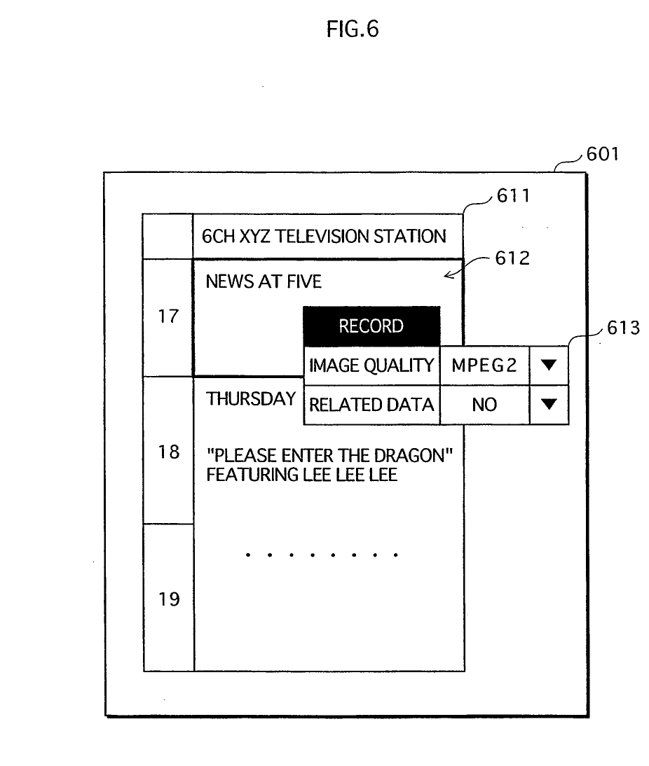

FIG. 6 illustrates an example of a GUI screen displayed on the display unit 54 in the terminal device 4 to receive an instruction from a user to instruct recording a program. FIG. 6 shows a screen 601 illustrating a program guide for a time period from 17:00 to 19:00, XYZ Television Company, and Channel 6 in the Osaka region.

A program guide 611 is generated based on the program guide information and a channel table (mentioned later), and displayed on the screen 601. When a program content section 612 is selected with a pointer, a recording instruction window 613 is displayed.

The recording instruction window 613 has three GUI buttons, which are a recording instruction button “RECORD”, an image quality selecting button, and a related data selecting button. The user can designate the image quality of program data to be recorded, by selecting one of a plurality of image quality options displayed when the image quality selecting button is pressed.

Also, the user can select whether related data should be generated regarding recorded program data by selecting one of YES and NO options displayed when the related data selecting button is pressed.

Furthermore, the user can issue a recording instruction for the program to the terminal device 4, by pressing the recording instruction button.

The operating unit 41 receives various kinds of instructions from the user. The operating unit 41 sends a recording instruction and a playback instruction from the user to the transmission information generating unit 42.

The transmission information generating unit 42 has a function of generating recording instruction information or playback instruction information to be transmitted to the recording server 2, based on a recording or playback instruction received from the user.

The recording instruction information includes user profile information indicating a user profile selected by the profile selecting unit 44 (described later).

When generating recording instruction information, the transmission information generating unit 42 stores information made up of generation date and time, a program ID, and a genre ID in the recording instruction history storing unit 43. The transmission information generating unit 42 sends recording or playback instruction information to the network communication unit 46.

The recording instruction history storing unit 43 is a memory area for storing a history of recording instructions.

The profile selecting rule obtaining unit 47 has a function of obtaining a profile selecting rule transmitted from the recording server 2.

Here, a user profile is attribute information indicating a different one of a plurality of groups that belong to a specific category. A user profile does not uniquely identify a user or a terminal device. For example, information indicating an attribute such as a favorite program genre, or age may be used as a user profile.

In the case of program genre, animated cartoons, news, variety shows and the like may be used as user profiles. In the case of age, 10-19 years of age, 20-29 years of age, 30-39 years of age and the like may be used as user profiles.

Alternatively, information indicating gender or inhabited area may be used as user profiles. Also, different kinds of attribute information may be combined to define a user profile. For example, attributes such as an inhabited area, age, gender, and a favorite program genre may be combined. If such is the case, for example, a user profile “a male who is in his twenties, lives in Osaka and likes animated cartoons”, or a user profile “a male who is in his fifties, lives in Kyoto, and likes samurai dramas” may be used.

Furthermore, two or more different favorite program genres may be combined, to define, for example, a user profile representing that favorite program genres are sports and movies. Also, attributes indicating gender and age may be combined, to define, for example, a user profile representing a couple of a male at age of 25-35 years and a female at age of 20-25 years.

A profile selecting rule is used to select a user profile to which the user belongs, from a plurality of user profiles. There are presumably several different profile selecting rules. The present embodiment employs the following rule. A history of recording instruction received from the user (hereinafter referred to as a recording instruction history) is reviewed, to determine which genre ID appears the largest number of times in the history. A user profile corresponding to the determined genre ID is selected as the user profile to which the user belongs.

For example, it is assumed that a genre ID 1 indicates news. If the number of recording instructions for programs belonging to the genre ID 1 is the largest of all genres, a user profile 1 which represents preference for news is selected as a user profile to which the user belongs.

If more than one genre IDs appear the largest number of times in the recording instruction history, a user profile corresponding to a genre ID which appears the most recently among the genre IDs in the history is set as the user profile to which the user belongs, according to the rule used in the present embodiment.

The profile selecting rule storing unit 45 is a memory area for storing the profile selecting rule obtained by the profile selecting rule obtaining unit 47.

The profile selecting unit 44 has a function of selecting a user profile to which the user belongs, based on the profile selecting rule stored in the profile selecting rule storing unit 45. The selected user profile is sent to the transmission information generating unit 42 and the recommended program notifying data generating unit 52 as user profile information.

The selected program information obtaining unit 48 has a function of obtaining selected program information transmitted from the recording server 2. The selected program information is described in detail later.

The selected program information storing unit 51 is a memory area for storing the selected program information obtained by the selected program information obtaining unit 48.

The recommended program notifying data generating unit 52 has a function of extracting program information that corresponds to the user profile information sent from the profile selecting unit 44, from the selected program information stored in the selected program information storing unit 51. The recommended program notifying data generating unit 52 generates recommended program notifying data including the extracted program information. The recommended program notifying data is caption information, and is sent to the playback unit 53.

The recorded data obtaining unit 49 has a function of obtaining recorded data transmitted from the recording server 2. The recorded data obtaining unit 49 obtains the recorded data using either a download method or a streaming method. The recorded data obtaining unit 49 stores the recorded data in the recorded data storing unit 50.

The recorded data storing unit 50 is a memory area for storing the recorded data obtained by the recorded data obtaining unit 49.

The playback unit 53 has a function of reading and playing back the recorded data stored in the recorded data storing unit 50. When receiving the recommended program notifying data, which is caption information, from the recommended program notifying data generating unit 52, the playback unit 53 displays a caption indicated by the recommended program notifying data on a screen on which the recorded data is displayed.

The display unit 54 has a function of outputting video and audio played back by the playback unit 53.

(1.2. Construction of the Recording Server 2)

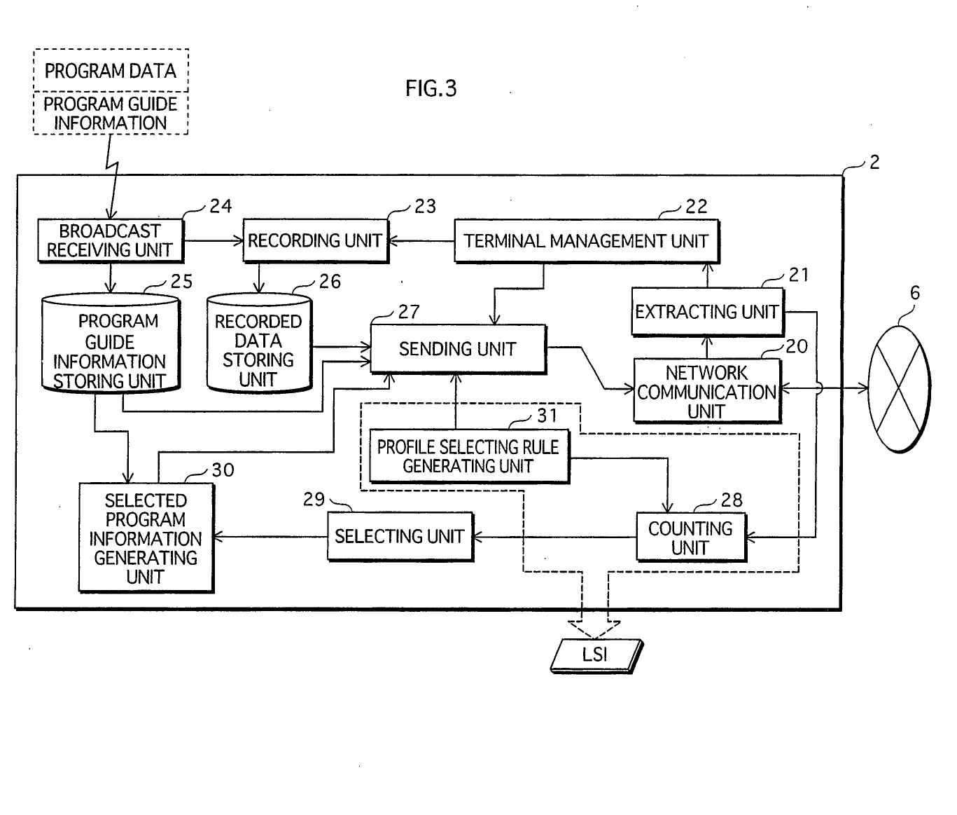

The following part describes functional units of the recording server 2 with reference to FIG. 3.

The recording server 2 includes a network communication unit 20, an extracting unit 21, a terminal management unit 22, a recording unit 23, a broadcast receiving unit 24, a program guide information storing unit 25, a recorded data storing unit 26, a sending unit 27, a counting unit 28, a selecting unit 29, a selected program information generating unit 30, and a profile selecting rule generating unit 31. The functional units of the recording server 2 are realized in such a manner that a CPU executes a recording server control program stored in a memory or a hard disk.

As shown in FIG. 3, the counting unit 28 and the profile selecting rule generating unit 31 are formed as an integrated circuit.

The network communication unit 20 has a function of communicating with other devices connected to the network 6. The network communication unit 20 is realized by hardware such as a LAN card or a modem.

The extracting unit 21 has a function of extracting a program ID and user profile information from recording instruction information transmitted from any of the terminal devices 3, 4 and 5. The extracted program ID and user profile information are sent to the counting unit 28. The recording instruction information is sent to the terminal management unit 22.

The terminal management unit 22 has a function of managing recording instruction information and playback instruction information transmitted from each of the terminal devices 3, 4 and 5. The terminal management unit 22 sends the recording instruction information to the recording unit 23, and the playback instruction information to the sending unit 27.

The broadcast receiving unit 24 has a function of receiving digital broadcasts and demodulating broadcast waves. The digital broadcast referred to here uses the MPEG-2-Transport Stream (TS) method, which is defined by ISO/IEC 13818. A TS includes the program guide information and the like in addition to program data.

The program guide information includes a plurality of pieces of table information, which include Program Specific Information (PSI) and Service Information (SI). PSI and SI are each defined by the MPEG-2 standard.

A TS is formed by TS packets which each have a payload and a header. The header stores identifying information to identify the contents of the payload. The broadcast receiving unit 24 separates and extracts particular data based on this identifying information in a header. The program guide information is extracted and sent to the program guide information storing unit 25. Program data is extracted and sent to the recording unit 23.

The recording unit 23 performs a recording operation of a program identified by the program ID included in the recording instruction information. The recording operation includes not only recording of broadcasted data in its original format, but also conversion of a format of recorded data into a format desired by a user. For example, the recording unit 23 converts program data in the MPEG-2 format into data in the MPEG-4 format. Data of the recorded program, that is to say, recorded data is stored in the recorded data storing unit 26.

The recorded data storing unit 26 is a memory area for storing recorded data.

The counting unit 28 has a function of receiving combinations of a program ID and user profile information from the extracting unit 21 and counting the number of times, for each user profile, each program ID has been received. The counting unit 28 sends program ID counting information, which is the result of the above-mentioned counting, to the selecting unit 29 at predetermined time intervals.

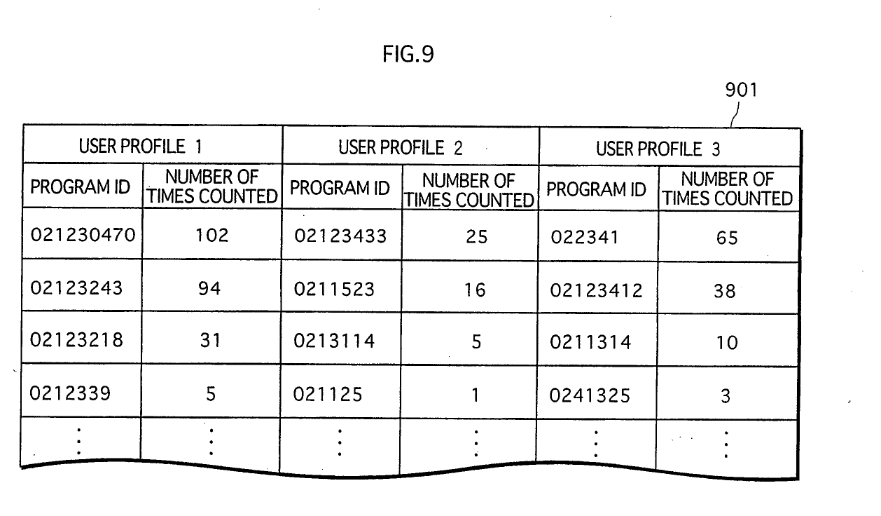

FIG. 9 illustrates a concrete example of the program ID counting information obtained by the counting unit 28 as a result of counting the number of times, for each user profile, each program ID has been received in the predetermined time.

Program ID counting information 901 is divided into three pieces of information, which respectively correspond to the user profiles 1, 2 and 3. The program ID counting information 901 shows the number of times, for each user profile, each program ID has been received.

The selecting unit 29 has a function of selecting, for each user profile, a program ID that is designated by recording instructions the largest number of times, based on the program ID counting information sent from the counting unit 28 at predetermined time intervals. The selecting unit 29 sends the selected program IDs corresponding to user profiles to the selected program information generating unit 30.

The selected program information generating unit 30 has a function of generating selected program information. The selected program information shows a one-to-one correspondence between a plurality of pieces of program information and a plurality of pieces of user profile information. Program information includes start date and time of a program indicated by a program ID selected for a corresponding user profile by the selecting unit 29, a recommendation text and the like.

The recording server 2 stores a plurality of recommendation text templates in a memory or a hard disk. The program information is generated by adding information such as a program genre of a program selected by the selecting unit 29, a title of the program, a name of a broadcasting station for the program, a channel number for the program, and the start date and time of the program, to a recommendation text template that is randomly selected. The information such as the program genre of the selected program, the title of the program, the name of the broadcasting station for the program, and the start date and time of the program can be extracted from the program guide information using a program ID identifying the program as a key.

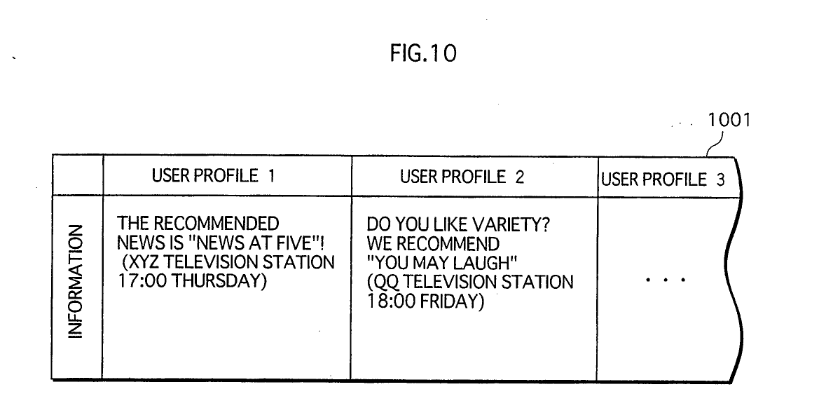

FIG. 10 illustrates a concrete example of the selected program information generated by the selected program information generating unit 30. In selected program information 1001, a recommendation text template corresponding to a user profile 1 is “The recommended ●●●! (***)”. The program information is generated, by entering the program genre of the selected program into ◯◯◯, the title of the program into ●●●, and the broadcasting station and the start date and time of the program into ***. The selected program information is sent to the sending unit 27.

The profile selecting rule generating unit 31 has a function of generating a profile selecting rule, based on a profile selecting rule template prestored in a memory or a hard disk in the recording server 2 and information input by a service provider. The profile selecting rule is sent to the sending unit 27.

The sending unit 27 has a function of reading recorded data corresponding to playback instruction information sent from the terminal management unit 22, to transmit, using a protocol such as the HyperText Transfer Protocol (HTTP) or the File Transfer Protocol (FTP), the read recorded data to a terminal device which has issued the playback instruction. Also, the sending unit 27 has a function of transmitting, for example, the program guide information stored in the program guide information storing unit 25, the profile selecting rule sent from the profile selecting rule generating unit 31, or the selected program information, using the above-mentioned protocol. Also, if the program indicated by the playback instruction information is not recorded, the sending unit 27 transmits error information to the terminal device which has transmitted the playback instruction information.

(2. Data)

The following part describes various kinds of data.

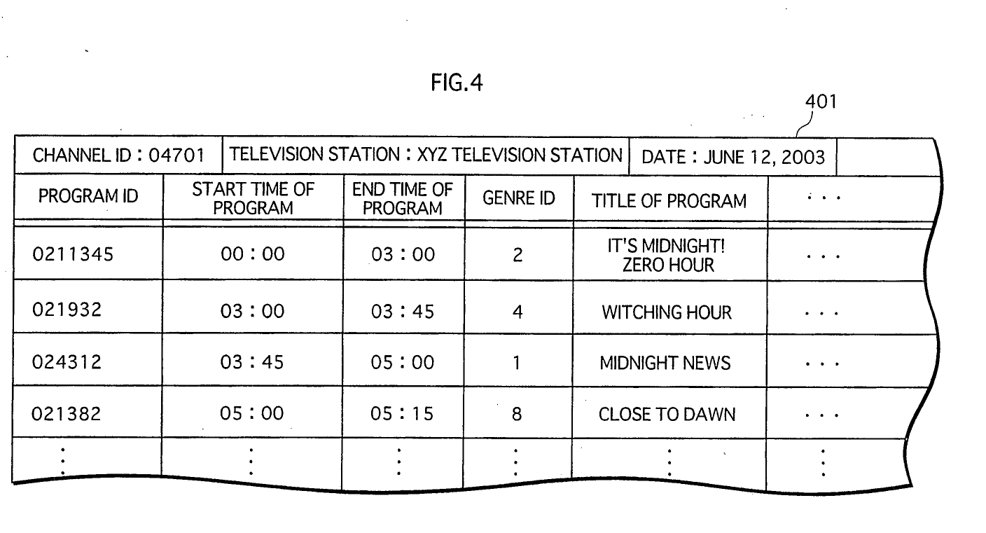

FIG. 4 illustrates a concrete example of the program guide information. Program guide information 401 is made up of item information which includes a channel ID, a television station, a date of broadcast, a program ID, a start time, an end time, a genre ID, and a program title.

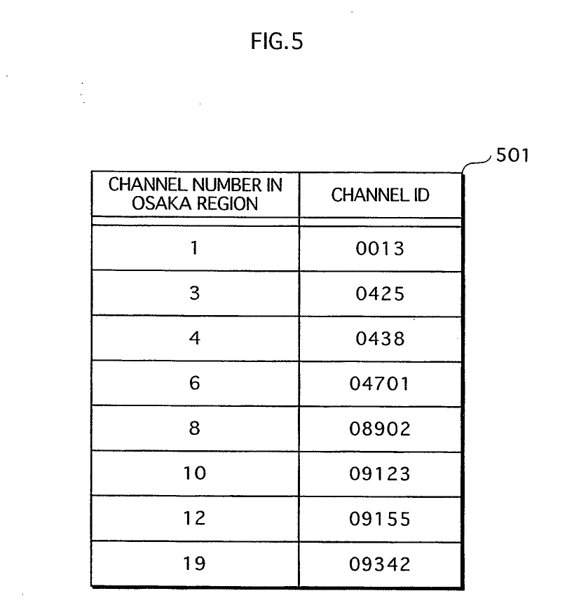

FIG. 5 illustrates a concrete example of the channel table. A channel table 501 shows a one-to-one correspondence between channel numbers that each represent a television station in the Osaka region and channel IDs.

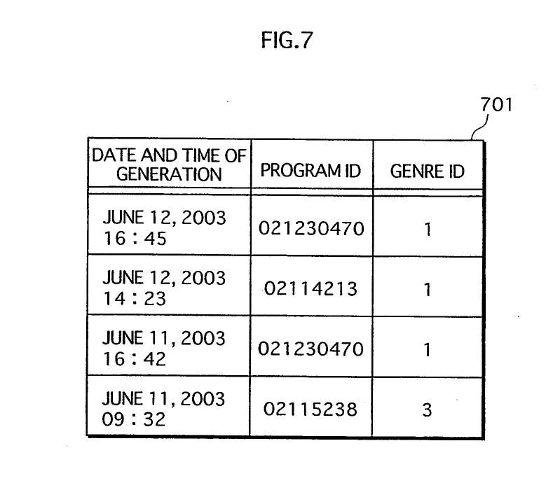

FIG. 7 illustrates a concrete example of the recording instruction history stored in the recording instruction history storing unit 43. A recording instruction history 701 stores a plurality of pieces of information which are each made up generation date and time of recording instruction information, a program ID of a program to be recorded, a genre ID of the program belongs, in chronological order.

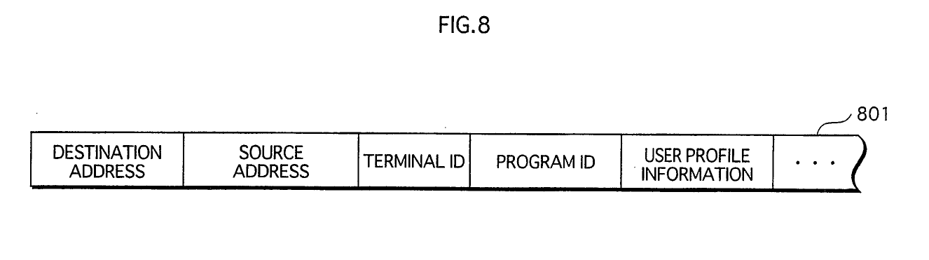

FIG. 8 illustrates a data construction of the recording instruction information transmitted from the terminal device 4 to the recording server 2.

Recording instruction information 801 is made up of a destination address, a source address, a terminal ID, a program ID, user profile information and the like.

(3. Operation)

The following part describes an operation of the network recording system 1.

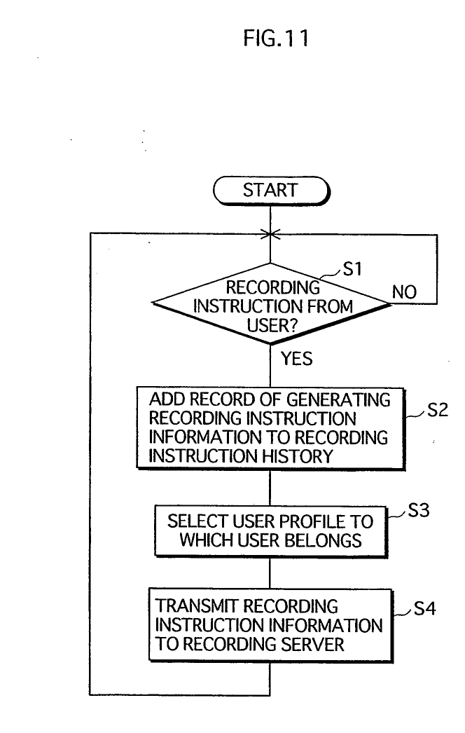

Firstly, an operation of the terminal device 4 from reception of a recording instruction from the user to transmission of recording instruction information to the recording server 2 is explained with reference to the flow chart shown in FIG. 11.

When the operating unit 41 in the terminal device 4 receives a recording instruction from the user (step S1: YES), the transmission information generating unit 42 generates recording instruction information, and adds information about the generation to the recording instruction history stored in the recording instruction history storing unit 43 (step S2).

After this, based on a profile selecting rule, the profile selecting unit 44 selects a user profile corresponding to a genre ID which appears in the recording instruction history the largest number of times as a user profile to which the user belongs. When more than one genre IDs appear the largest number of time in the recording instruction history, the profile selecting unit 44 selects a user profile corresponding to a genre ID, among the genre IDs, which appears in the recording instruction history the most recently as the user profile to which the user belongs (step S3).

The terminal device 4 transmits, to the recording sever 2, the recording instruction information which includes the program ID of the program indicated by the recording instruction from the user and user profile information indicating the user profile that has been selected by the profile selecting unit 44 (step S4).

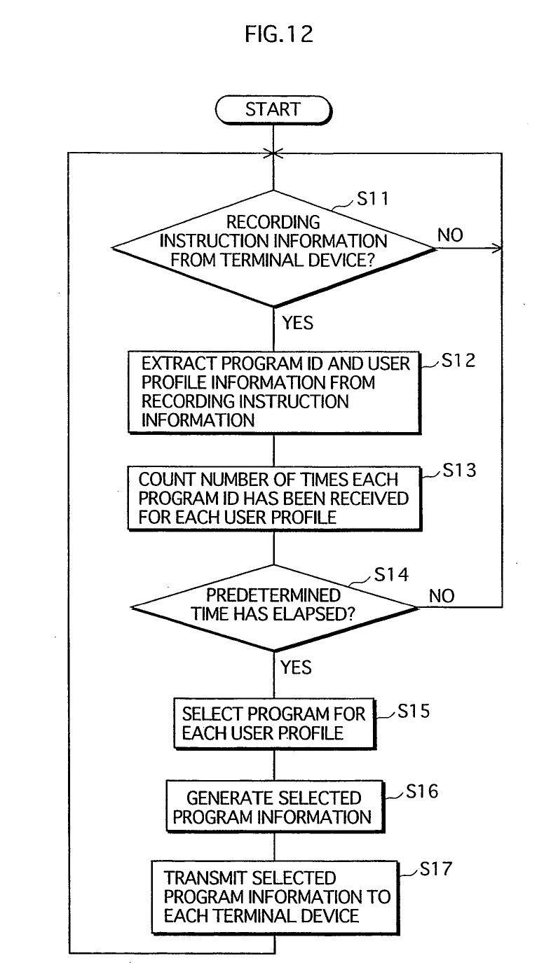

Secondly, an operation of the recording server 2 from reception of the recording instruction information to transmission of selected program information to each of the terminal devices 3, 4 and 5 is explained with reference to the flow chart shown in FIG. 12.

When the recording server 2 receives the recording instruction information from the terminal device 3, 4 or 5 (step S11: YES), the extracting unit 21 extracts the combination of the program ID and the user profile information included in the recording instruction information (step S12).

The combination of the extracted program ID and user profile information are sent to the counting unit 28. The counting unit 28 counts the number of times, for each user profile, each program ID has been received (step S13).

The counting unit 28 sends program ID counting information, which is obtained as a result of the counting, to the selecting unit 29 at predetermined time intervals. Therefore, when the predetermined time has elapsed (step S14: YES), the selecting unit 29 selects a program which is designated by recording instructions the largest number of times for each user profile (step S15). If the predetermined time has not elapsed (step S14: NO), the operation goes back to the step S11.

The selected program information generating unit 30 receives program IDs of programs selected in the step S15, and generates selected program information (step S16).

The sending unit 27 transmits the selected program information to each of the terminal devices 3, 4 and 5 using a predetermined protocol (step S17).

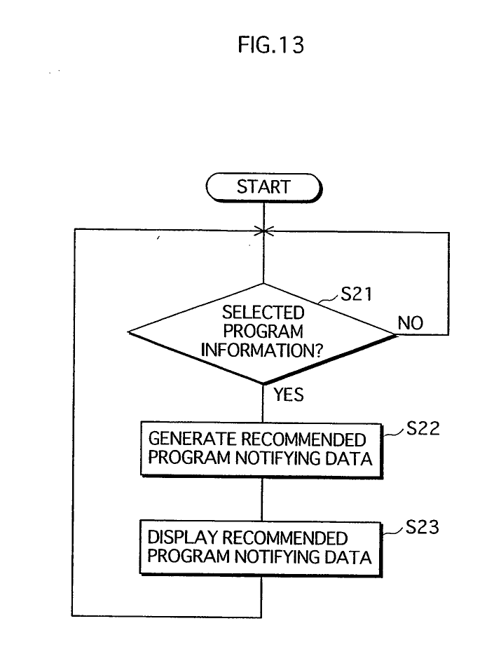

Lastly, an operation of the terminal device 4 from reception of the selected program information to display of a caption for a recommended program, with reference to the flow chart shown in FIG. 13.

When the terminal device 4 receives the selected program information from the recording server 2 (step S21: YES), the recommended program notifying data generating unit 52 extracts, from the selected program information, program information corresponding to the user profile information received from the profile selecting unit 44, and generates recommended program notifying data including the extracted program information (step S22).

The recommended program notifying data is sent to the playback unit 53. The playback unit 53 displays a caption indicated by the recommended program notifying data on a display screen on which recorded data is played back (step S23).

(4. Modification Example)

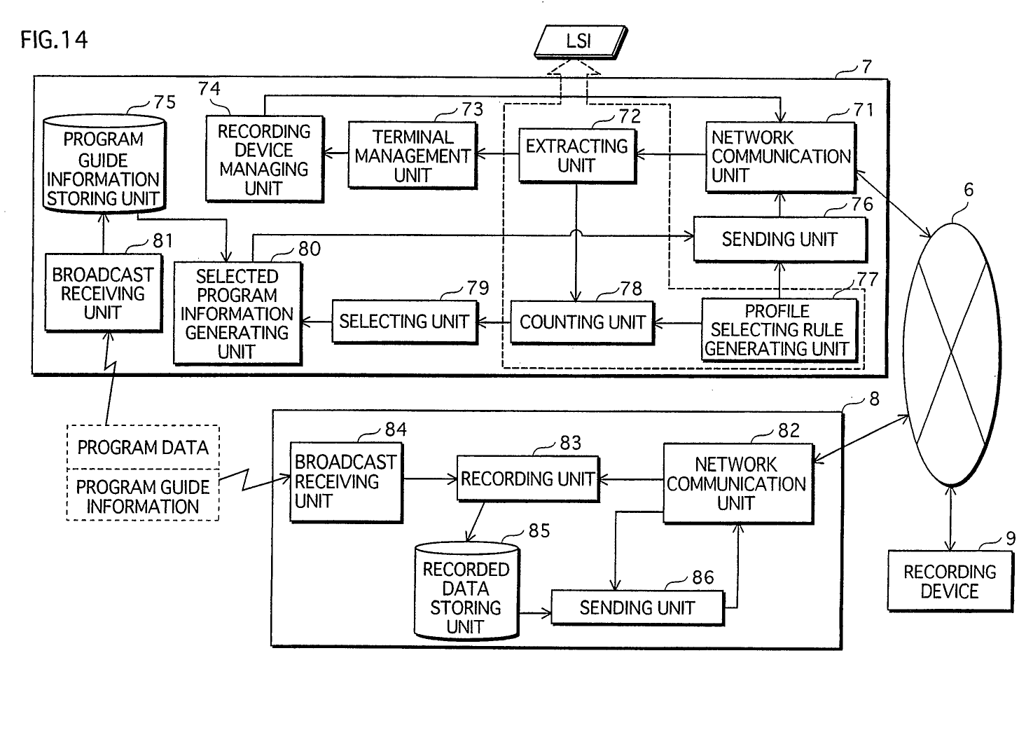

The above-described embodiment may be modified in the following manner. The functional units of the recording server 2 shown in FIG. 3 may be realized by a plurality of devices, for example, by a recording management device 7, and recording devices 8 and 9 as shown in FIG. 14.

The recording management device 7 manages the recording devices 8 and 9. When receiving recording instruction information from the terminal device 3, 4 or 5, the recording management device 7 has the recording devices 8 and 9 perform a recording operation of a program designated by the recording instruction information. Furthermore, the recording management device 7 extracts a combination of a program ID and user profile information from the recording instruction information, so as to count, for each user profile, the number of times each program ID has been received. The recording management device 7 includes a network communication unit 71, an extracting unit 72, a terminal management unit 73, a recording device managing unit 74, a program guide information storing unit 75, a sending unit 76, a profile selecting rule generating unit 77, a counting unit 78, a selecting unit 79, a selected program information generating unit 80, and a broadcast receiving unit 81.

The functional units of the recording management device 7 are realized in such a manner that a CPU executes a control program for a recording management device stored in a memory or a hard disk.

The functional units except for the recording device managing unit 74 are the same as the network communication unit 20, the extracting unit 21, the terminal management unit 22, the recording unit 23, the broadcast receiving unit 24, the program guide information storing unit 25, the recorded data storing unit 26, the sending unit 27, the counting unit 28, the selecting unit 29, the selected program information generating unit 30, and the profile selecting rule generating unit 31 included in the recording server 2. Therefore, those functional units are not explained.

As shown in FIG. 14, the extracting unit 72, the profile selecting rule generating unit 77, and the counting unit 78 are formed as an integrated circuit.

The recording device managing unit 74 manages a plurality of recording devices each of which records programs on a particular channel. The recording device managing unit 74 has a function of performing a recording control and a data transmission control on the recording devices 8 and 9 connected to the network 6.

FIG. 14 only illustrates the two recording devices 8 and 9. However, the number of recording devices connected to the network 6 may be several ten so as to be equal to the number of channels. The recording devices 8 and 9 have the same functions. As shown in FIG. 14, the recording device 8 includes a network communication unit 82, a recording unit 83, a broadcast receiving unit 84, a recorded data storing unit 85, and a sending unit 86. These functional units are the same as the network communication unit 20, the recording unit 23, the broadcast receiving unit 24, the recorded data storing unit 26, and the sending unit 27 included in the recording server 2 respectively.

The recording devices 8 and 9 performs a recording operation of a program and transmits recorded data, in accordance with an instruction from the recording management device 7.

(5. Other Information)

The present invention is not limited to the embodiment, and includes the following modifications.

(1) A profile selecting rule may be defined so as that a user profile to which the user belongs is selected based on personal information input by the user. For example, a case is assumed where a user profile to which the user belongs is selected based on user's age. If the user inputs age information indicating 25 years of age, a user profile of 20-29 years of age is selected as a user profile to which the user belongs. If the user inputs age information indicating 36 years of age, a user profile of 30-39 years of age is selected as a user profile to which the user belongs.

(2) According to the above-described embodiment, the terminal devices 3, 4 and 5 receive a recording instruction from the user. However, the terminal devices 3, 4 and 5 may receive a designation of a program from the user. In this case, the present invention may realize a designated program counting system including a plurality of terminal devices and a server.

The terminal devices included in the system each transmit designation information containing a combination of a program ID of the program designated by the user and user profile information, to the server. The server receives the designation information from each of the terminal devices, and counts, for each user profile, the number of times each program ID has been received.

Here, the designation of the program from the user may be made in order to obtain the program from the server, or to vote on a popularity poll about programs.

(3) The present invention may include a program counting method including the procedure in which the recording server 2 counts the number of times, for each user profile, each program ID has been received (FIG. 9) as described in the embodiment, and a computer-readable program to have the recording server 2 perform a program counting operation. The computer-readable program can be distributed in a state of being stored in storage media or via various kinds of communication paths. Such storage media include IC cards, optical disks, flexible disks, and memories.

When distributed, the computer-readable program may be installed, for example, in a device with a storing unit to be used. The device performs the program counting operation described in the embodiment, by executing the computer-readable program.

(4) According to the embodiment, the profile selecting unit 44, the profile selecting rule storing unit 45, and the profile selecting rule obtaining unit 47 are formed as an integrated circuit. The same holds true for the counting unit 28 and the profile selecting rule generating unit 31, and the extracting unit 72, the profile selecting rule generating unit 77 and the counting unit 78. However, each of these functional units may be formed as a one-chip integrated circuit.

A one-chip integrated circuit including the selected program information obtaining unit 48, the selected program information storing unit 51, and the recommended program notifying data generating unit 52 in addition to the profile selecting unit 44, the profile selecting rule storing unit 45, and the profile selecting rule obtaining unit 47 may be used for the terminal device 4 shown in FIG. 2. Furthermore, an integrated circuit including the transmission information generating unit 42 and the recording instruction history storing unit 43 in addition to the above-mentioned functional units may be used.

A one-chip integrated circuit including the selecting unit 29 and the selected program information generating unit 30 in addition to the counting unit 28 and the profile selecting rule generating unit 31 may be used for the recording server 2 shown in FIG. 3. Furthermore, an integrated circuit including the extracting unit 21 and the network communication unit 20 in addition to the above-mentioned functional units may be used.

The integrated circuits may be called LSI depending on the degree of the integration of the devices.

A special-purpose circuit, a general processor, or a Field Programmable Gate Array (FPGA) Reconfigureable Processor that can change the architecture may be used for the integrated circuits. In addition, if advance in technology enables a replacement for a semiconductor integrated circuit to be developed, for example, an integrated circuit using a biotechnology, the new type of integrated circuit can be used for the integrated circuits as well.

### INDUSTRIAL APPLICABILITY

The present invention can be employed for a network recording system to provide a program recording service.

1. A network recording system including a terminal device and a recording server which are connected to a network,
the terminal device comprising:
a receiving unit operable to receive a designation of a program to be recorded, from a user;
a selecting unit operable to select a user profile to which the user belongs, out of a plurality of user profiles; and
a transmitting unit operable to transmit recording instruction information to the recording server, the recording instruction information including a combination of a program ID identifying the program to be recorded and user profile information showing the user profile to which the user belongs, and
the recording server comprising:
a reception unit operable to receive the recording instruction information from the terminal device;
a recording unit operable to record the program identified by the program ID included in the recording instruction information; and
a counting unit operable to count, for each of the plurality of user profiles, a number of times each program ID has been received by the reception unit.

2. The network recording system of claim 1, wherein
the recording server further comprises:
a rule generating unit operable to generate a rule to select the user profile to which the user belongs; and
a transmission unit operable to transmit the generated rule to the terminal device,
the terminal device further comprises:
a rule storing unit operable to receive and store the rule transmitted from the recording server, and
the selecting unit selects the user profile to which the user belongs, based on the rule stored in the rule storing unit.

3. The network recording system of claim 2, wherein
the recording server further comprises:
a selection unit operable to select a plurality of programs in one-to-one correspondence with the plurality of user profiles, based on a result of the counting performed by the counting unit,
the transmission unit generates selected program information and transmits the selected program information to the terminal device, the selected program information showing a one-to-one correspondence between (i) a plurality of pieces of program information that indicate the plurality of programs selected by the selection unit and (ii) a plurality of pieces of user profile information that represent the plurality of user profiles, and
the terminal device further comprises:
a presenting unit operable to receive the selected program information from the recording server, and present the selected program information to the user.

4. The network recording system of claim 3, wherein
the presenting unit extracts a piece of program information corresponding to the user profile to which the user belongs, from the selected program information, and presents the extracted piece of program information to the user.

5. The network recording system of claim 2, wherein
the terminal device further comprises:
a program guide information obtaining unit operable to obtain program guide information showing program IDs and corresponding genre IDs that represent program genres of programs identified by the program IDs; and
a history storing unit operable to, every time the receiving unit receives a designation of a program to be recorded, determine a genre ID corresponding to a program ID identifying the program to be recorded with reference to the program guide information, and count and record therein a number of times the genre ID is designated by the user, and
the selecting unit selects the user profile to which the user belongs, based on a result of the counting performed by the history storing unit and the rule stored in the rule storing unit.

6. The network recording system of claim 3, wherein
the terminal device further comprises:
a program guide information obtaining unit operable to obtain program guide information showing program IDs and corresponding genre IDs that represent program genres of programs identified by the program IDs; and
a history storing unit operable to, every time the receiving unit receives a designation of a program to be recorded, determine a genre ID corresponding to a program ID identifying the program to be recorded with reference to the program guide information, and count and record therein a number of times the genre ID is designated by the user, and
the selecting unit selects the user profile to which the user belongs, based on a result of the counting performed by the history storing unit and the rule stored in the rule storing unit.

7. The network recording system of claim 4, wherein
the terminal device further comprises:
a program guide information obtaining unit operable to obtain program guide information showing program IDs and corresponding genre IDs that represent program genres of programs identified by the program IDs; and
a history storing unit operable to, every time the receiving unit receives a designation of a program to be recorded, determine a genre ID corresponding to a program ID identifying the program to be recorded with reference to the program guide information, and count and record therein a number of times the genre ID is designated by the user, and
the selecting unit selects the user profile to which the user belongs, based on a result of the counting performed by the history storing unit and the rule stored in the rule storing unit.

8. The network recording system of claim 2, wherein
the receiving unit receives an input of personal information from the user, and
the selecting unit selects the user profile to which the user belongs, based on the personal information and the rule stored in the rule storing unit.

9. The network recording system of claim 3, wherein
the receiving unit receives an input of personal information from the user, and
the selecting unit selects the user profile to which the user belongs, based on the personal information and the rule stored in the rule storing unit.

10. The network recording system of claim 4, wherein
the receiving unit receives an input of personal information from the user, and
the selecting unit selects the user profile to which the user belongs, based on the personal information and the rule stored in the rule storing unit.

11. A recording server comprising:
a reception unit operable to receive, from an external device, recording instruction information including a combination of a program ID identifying a program and user profile information indicating a user profile to which a user belongs;
a recording unit operable to record the program identified by the program ID included in the recording instruction information; and
a counting unit operable to count, for each of a plurality of user profiles, a number of times each program ID has been received by the reception unit.

12. The recording server of claim 11, further comprising:
a selection unit operable to select programs in one-to-one correspondence with user profiles, based on a result of the counting performed by the counting unit; and
a transmission unit operable to generate selected program information and transmit the selected program information to the external device, the selected program information showing a one-to-one correspondence between (i) a plurality of pieces of program information that indicate the programs selected by the selection unit and (ii) a plurality of pieces of user profile information that represent the user profiles.

13. A terminal device comprising:
a receiving unit operable to receive a designation of a program to be recorded from a user;
a selecting unit operable to select a user profile to which the user belongs, out of a plurality of user profiles;
a transmitting unit operable to transmit recording instruction information to an external device, the recording instruction information including a program ID identifying the program to be recorded and user profile information indicating the user profile to which the user belongs;
a reception unit operable to receive, from the external device, selected program information showing a one-to-one correspondence between (i) a plurality of pieces of program information that respectively indicate programs and (ii) a plurality of pieces of user profile information which respectively represent the plurality of user profiles; and
a presenting unit operable to extract a piece of program information corresponding to the user profile to which the user belongs, from the selected program information and present the extracted piece of program information to the user.

14. A designated program counting system including a terminal device and a server which are connected to a network,
the terminal device comprising:
a receiving unit operable to receive a designation of a program, from a user;
a selecting unit operable to select a user profile to which the user belongs, out of a plurality of user profiles; and
a transmitting unit operable to transmit instruction information to the server, the instruction information including a combination of a program ID identifying the designated program and user profile information showing the user profile to which the user belongs, and
the server comprising:
a reception unit operable to receive the instruction information from the terminal device; and
a counting unit operable to count, for each of the plurality of user profiles, a number of times each program ID has been received by the reception unit.

15. A recording-instructed program counting method comprising steps of:
receiving recording instruction information including a combination of a program ID and user profile information;
recording a program identified by the program ID included in the recording instruction information; and
counting a number of times, for each of a plurality of user profiles, each program ID has been received in the receiving step.

16. A computer-readable program to cause a computer to execute a program counting operation comprising steps of:
receiving recording instruction information including a combination of a program ID and user profile information;
recording a program identified by the program ID included in the recording instruction information; and
counting a number of times, for each of a plurality of user profiles, each program ID has been received in the receiving step.

17. A computer-readable storage medium storing a computer-readable program which causes a computer to execute a program counting operation, the program counting operation comprising steps of:
receiving recording instruction information including a combination of a program ID and user profile information;
recording a program identified by the program ID included in the recording instruction information; and
counting a number of times, for each of a plurality of user profiles, each program ID has been received in the receiving step.

18. An integrated circuit for use in a recording server including a transmission unit operable to transmit, to a terminal device, a rule to select, out of a plurality of user profiles, a user profile to which a user belongs, a reception unit operable to receive recording instruction information including a combination of a program ID identifying a program to be recorded and user profile information indicating the user profile to which the user belongs, and a recording unit operable to record the program indicated by the program ID included in the recording instruction information, the integrated circuit comprising:
a rule generating unit operable to generate the rule; and
a counting unit operable to count, for each of the plurality of user profiles, a number of times each program ID has been received by the reception unit.

19. An integrated circuit for use in a terminal device including a receiving unit operable to receive, from an external device, a rule to select, out of a plurality of user profiles, a user profile to which a user belongs, the integrated circuit comprising:
a rule storing unit operable to store the rule received by the receiving unit; and
a selecting unit operable to select the user profile to which the user belongs, out of the plurality of user profiles, based on the rule stored in the rule storing unit.
